(19) United States
(12) Patent Application Publication
(10) Pub. No.: US 2025/0096330 A1
(43) Pub. Date: Mar. 20, 2025

(54) ELECTRODE LAMINATE AND BATTERY

(71) Applicant: TOYOTA JIDOSHA KABUSHIKI KAISHA, Toyota-shi (JP)

(72) Inventors: Hiroshi NAGASE, Nagoya-shi (JP); Kenichi KAKISHITA, Nagoya-shi (JP); Shinya ISHIKAWA, Toyota-shi (JP); Ryo KAGAMI, Ichinomiya-shi (JP); Norihiro OSE, Toyota-shi (JP)

(73) Assignee: TOYOTA JIDOSHA KABUSHIKI KAISHA, Toyota-shi (JP)

(21) Appl. No.: 18/668,407

(22) Filed: May 20, 2024

(30) Foreign Application Priority Data
Sep. 15, 2023 (JP) 2023-150405

(51) Int. Cl. H01M 10/0587; H01M 10/0525

(52) U.S. Cl. CPC H01M 10/0587; H01M 10/0525

(57) ABSTRACT

In the electrode laminate of the present disclosure, a fixing member including a curable resin is disposed on at least one side face portion. The fixing member has a thin film region and a thick film region. The thin film region is formed on at least one end portion including the terminal end of the fixing member, and the thick film region is formed at a portion other than the thin film region. The thickness of the fixing member is thinnest at the terminal end. Further, the battery of the present disclosure includes the electrode laminate of the present disclosure and a laminate film sealing the electrode laminate.

### CROSS-REFERENCE TO RELATED APPLICATION

This application claims priority to Japanese Patent Application No. 2023-150405 filed on Sep. 15, 2023, incorporated herein by reference in its entirety.

### BACKGROUND

### 1. Technical Field

The present disclosure relates to an electrode laminate and a battery.

### 2. Description of Related Art

In a secondary battery such as a lithium ion battery or the like, an electrode laminate may be used. With regard to such an electrode laminate, a technology has been developed in which a fixing member including a curable resin is provided on a side face portion of the electrode laminate, in order to suppress misalignment or the like of the layers.

For example, Japanese Unexamined Patent Application Publication No. 2021-114374 (JP 2021-114374 A) discloses a method for manufacturing an all-solid-state battery including a laminated electrode body (electrode laminate) that is flat, an exterior body that is made of a laminate film and that accommodates the laminated electrode body, and a protective member (fixing member) made of resin that is formed on a side face of the laminated electrode body.

JP 2021-114374 A also discloses use of a resin material having photocuring properties or thermosetting properties as the protective member.

### SUMMARY

The fixing member including the curable resin may peel away from the electrode laminate, and as a result, there is a problem that functions for serving as the fixing member cannot be sufficiently exhibited.

An object of the present disclosure is to provide an electrode laminate in which a fixing member disposed on a side face portion thereof does not readily peel off, and a battery having such an electrode laminate.

The disclosers of the present disclosure found that the above issue can be solved by the following means.

### First Aspect

An electrode laminate, provided with a fixing member that includes a curable resin and that is disposed on at least one side face portion, in which the fixing member includes a thin film region and a thick film region, and the thin film region is fashioned on at least one end portion including a terminal end of the fixing member, and the thick film region is fashioned in a portion other than the thin film region.

### Second Aspect

The electrode laminate according to the first aspect, in which a thickness of the fixing member is thinnest at the terminal end, and a thickness of the terminal end is no more than 50% of a thickness of the thick film region.

### Third Aspect

The electrode laminate according to the first or second aspects, in which a length of the thin film region is no less than 1 mm.

### Fourth Aspect

The electrode laminate according to any one of the first to third aspects, in which a thickness of the thick film region is no less than 50 μm and no more than 5 mm.

### Fifth Aspect

A battery, including
the electrode laminate according to any one of the first to fourth aspects, and
a laminate film that seals the electrode laminate.

According to the present disclosure, an electrode laminate in which a fixing member disposed on a side face portion thereof does not readily peel away, and a battery having such an electrode laminate, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic diagram illustrating an example of an electrode laminate according to the present disclosure;

FIG. 1B is a schematic diagram illustrating an example of an electrode laminate according to the present disclosure;

FIG. 2A is an enlarged view of the region of the fixing member near the thin film region in the electrode laminate of the present disclosure;

FIG. 2B is an enlarged view of the region of the fixing member near the thin film region in the electrode laminate of the present disclosure;

FIG. 3 is a schematic plan view of an exemplary disclosed cell; and

FIG. 4 is a schematic diagram of an electrode laminate according to the prior art.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Electrode Laminate

In the electrode laminate of the present disclosure, a fixing member including a curable resin is disposed on at least one side face portion. The fixing member has a thin film region and a thick film region. The thin film region is formed at least one end portion including the terminal end of the fixing member, and the thick film region is formed at a portion other than the thin film region.

The Discloser and others thought that one of the causes of the fixing member including the curable resin being peeled off from the electrode laminate was due to the stress generated with the hardening shrinkage of the curable resin.

In this regard, the inventors of the present disclosure have found that by forming a thin film region in which the thickness of the fixing member is thinner than that of the thick film region on at least one end portion including the terminal end of the fixing member, it is possible to prevent the fixing member including the curable resin from being peeled off from the electrode laminate. The reason for this is not intended to be bound by any theory, but it is considered that by providing the difference in thickness as described above in the fixing member, it is possible to relax the stress generated in association with the curing shrinkage of the curable resin.

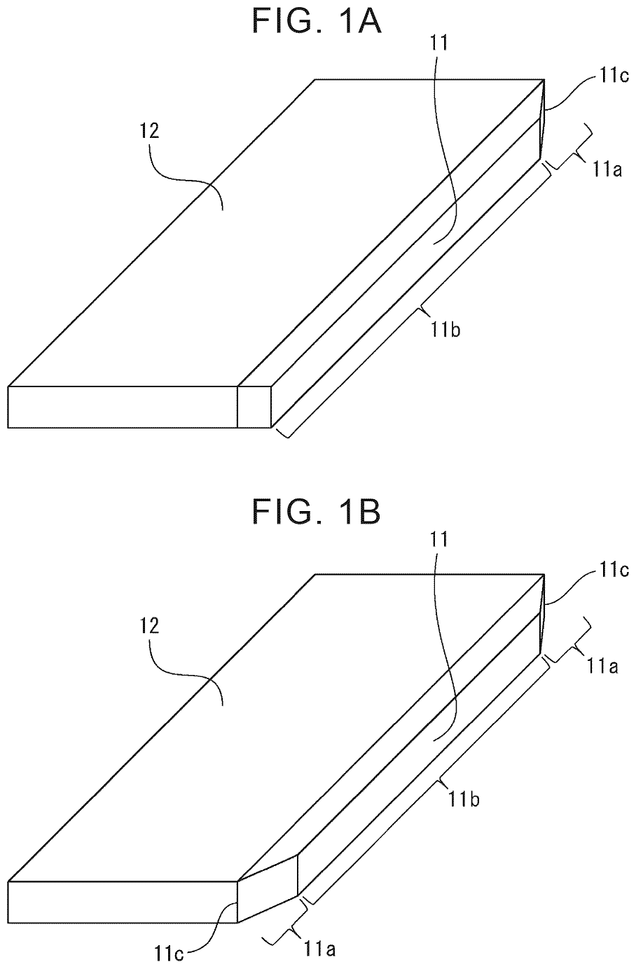

Referring now to FIGS. 1A and 1B, the disclosed electrode laminate 12 will now be described. Note that dimensional relationships (length, width, thickness, and the like) in FIGS. 1A and 1B, and the rest of the drawings do not reflect actual dimensional relationships. FIGS. 1A and 1B are schematic diagrams illustrating an exemplary electrode laminate 12 of the present disclosure. The configuration of the electrode laminate 12 is not particularly limited, but includes, for example, a top surface portion, a bottom surface portion opposed to the top surface portion, and four side face portions connecting the top surface portion and the bottom surface portion, as shown in FIGS. 1A and 1B. Further, in the electrode laminate 12 of the present disclosure, the fixing member 11 including the curable resin is disposed on at least one side face portion.

In the present disclosure, the term “electrode laminate” means a stack constituting one or a plurality of unit cells. Here, the “unit cell” may include a laminate of a positive electrode current collector layer, a positive electrode active material layer, an electrolyte layer (separator layer), a negative electrode active material layer, and a negative electrode current collector layer.

The fixing member 11 may be disposed on two or more side face portions of the electrode laminate 12. In particular, a fixing member may be disposed on a pair of opposing side face portions of the electrode laminate 12, and another member such as a terminal may be disposed on the remaining pair of side face portions. In this case, the effect of suppressing the displacement of the electrode by the fixing member 11 is improved, and it is easy to prevent the short circuit caused by the mixing of the conductive foreign matter and the damage caused by the external impact.

Examples of the curable resin include, but are not limited to, photocurable resins such as ultraviolet curable resins and electron beam curable resins, and thermosetting resins. The curable resin may be a radically polymerizable resin, a cationically polymerizable resin, or a combination thereof.

As shown in FIG. 1A, in the electrode laminate 12 of the present disclosure, the fixing member 11 has a thin film region 11a and a thick film region 11b. The thin film region 11a is formed on at least one end portion including the terminal end 11c of the fixing member 11, and the thick film region 11b is formed at a portion other than the thin film region 11a. With such a configuration, as described above, it is possible to relax the stress generated in association with the curing shrinkage of the curable resin, and as a result, it is considered that peeling off of the fixing member 11 from the electrode laminate 12 can be suppressed.

The “thin film region” means a region in which the thickness of the fixing member is relatively smaller than that of the thick film region, and the “thick film region” means a region in which the thickness of the fixing member is relatively larger than that of the thin film region.

As shown in FIG. 1B, the thin film regions 11a may be formed on both of the fixing members 11. With such a configuration, the effect of relaxing the stress generated due to the curing shrinkage of the curable resin is improved, and it is possible to more effectively prevent the fixing member 11 from being peeled off from the electrode laminate 12.

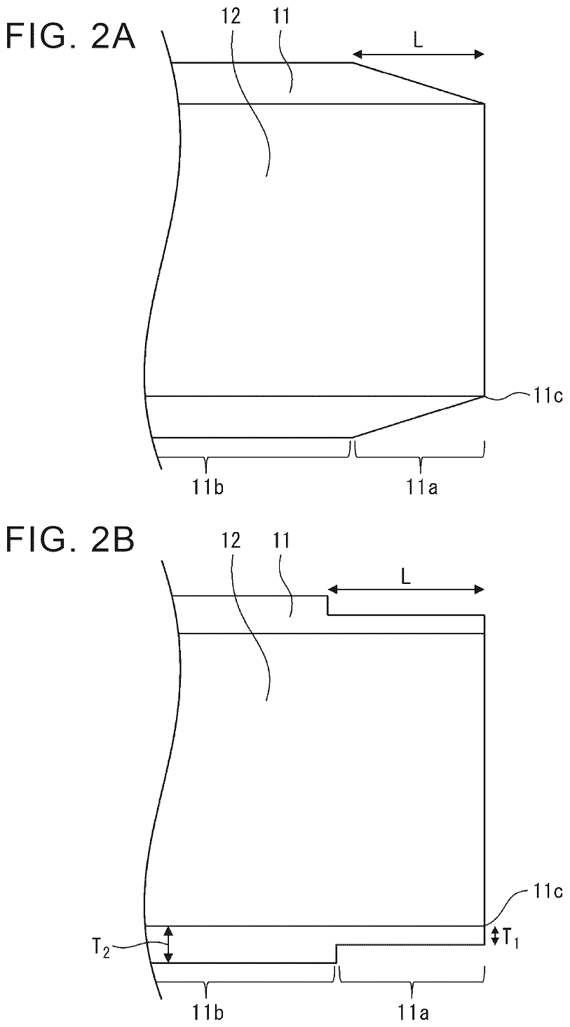

FIGS. 2A and 2B are diagrams illustrating an enlarged view of the vicinity of a thin film region 11a of a fixing member 11 in a schematic plan view of an electrode laminate 12 according to an embodiment of the present disclosure as viewed in plan from a stacking direction. As shown in FIG. 2A, the fixing member 11 may have a shape in which the thickness gradually decreases toward the terminal end 11c in the thin film region 11a. Further, as shown in FIG. 2B, the fixing member 11 may be shaped to have a step such that the thickness of the terminal end 11c is minimized in the thin film region 11a.

As a method of disposing the fixing member 11 in this manner, for example, there is a method of applying an ultraviolet curable resin to a side face portion of the electrode laminate such that, when applying the ultraviolet curable resin using a dispenser, the end discharge amount is adjusted, the thickness of the end portion including the terminal end at the side face portion of the electrode laminate is reduced, and the thickness of the other portion is increased.

The thickness of the thin film region 11a is thinnest in the terminal end 11c, and the thickness T₁ of the terminal end 11c may be 50% or less of the thickness T₂ of the thick film region 11b. Thickness of the terminal end 11c of the thin film region may be greater than 0 μm, greater than or equal to 25 μm, greater than or equal to 50 μm, or greater than or equal to 100 μm, and may be less than or equal to 2.5 mm, less than or equal to 2.0 mm, less than or equal to 1.5 mm, or less than or equal to 1.0 mm. Also, the thickness T₁ may be 0.4 mm.

The length L of the thin film region 11a may be equal to or greater than 1 mm. The length L may be greater than or equal to 2 mm, greater than or equal to 3 mm, or greater than or equal to 4 mm, and may be less than or equal to 10 mm, less than or equal to 8 mm, or less than or equal to 6 mm. The length L may be 5 mm.

The thickness T₂ of the thick film region 11b may be greater than or equal to 50 μm and less than or equal to 5 mm. The thickness T₂ may be greater than or equal to 100 μm, greater than or equal to 500 μm, or greater than or equal to 800 μm, and may be less than or equal to 4 mm, less than or equal to 3 mm, or less than or equal to 2 mm. Also, the thickness T₂ may be 1 mm. When the thickness T₂ is large, it is easy to prevent misalignment of the electrodes and short-circuiting due to mixing of conductive foreign matters. When the thickness T₂ is thin, the energy-density of the cell can be reduced, and stresses generated due to the curing shrinkage of the curable resin are easily suppressed. Note that the thickness T₂ may be the mean thickness of the entire fixing member 11.

As a method of preparing the thickness T₂ of the thick film region 11b, for example, a method of preparing the viscosity at the time of application of the curable resin for forming the fixing member 11 is exemplified.

The length of the fixing member 11 in the stacking direction of the electrode laminate 12 may be smaller than the thickness of the electrode laminate 12.

### Battery

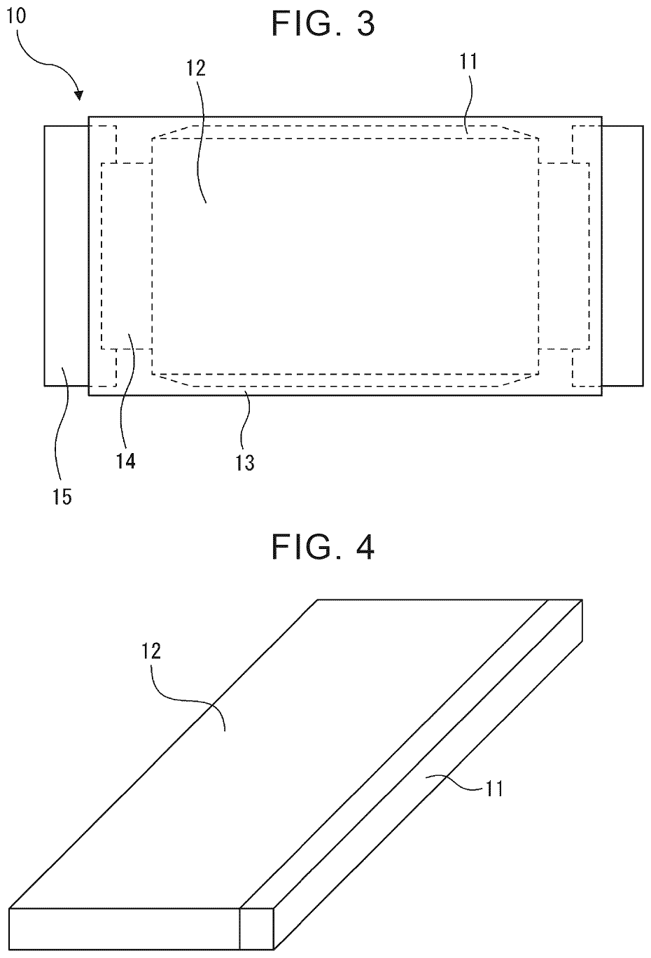

Hereinafter, the battery 10 of the present disclosure will be described with reference to FIG. 3. FIG. 3 is a schematic plan view illustrating an example of the battery 10 of the present disclosure when viewed in plan from the stacking direction of the electrode laminate 12.

As shown in FIG. 3, a battery 10 of the present disclosure includes an electrode laminate 12 of the present disclosure and a laminate film 13 that seals the electrode laminate 12.

### Electrode Laminate

The electrode laminate 12 functions as a power generation element of a battery. For the electrode laminate 12, reference can be made to the above description of the electrode laminate of the present disclosure.

### Laminate Film

The laminate film 13 optionally winds the electrode laminate 12 to seal the electrode laminate 12. The laminate film 13 may include a welded layer and a metal layer, and the electrode laminate 12 may be sealed by, for example, welding the welded layers and/or the welded layer and a current collector terminal 15 to be described later. The material of the welding layer may be, for example, a resin that can be welded by heat.

As shown in FIG. 3, the battery 10 of the present disclosure may further include a current collector terminal 15 electrically connected to the current collector foil 14 of the electrode laminate 12. The laminate film 13 may wrap the electrode laminate 12 and the current collector terminal 15 to seal the electrode laminate 12 together with the current collector terminal 15.

### Current Collector Foil

The current collector foil 14 may extend from a side face portion of the side face portion of the electrode laminate 12 where the fixing member 11 is not disposed. The current collector foil 14 may be a bundle of portions of the positive electrode current collector of the electrode laminate 12 where other layers are not laminated, and a bundle of portions of the negative electrode current collector of the electrode laminate 12 where other layers are not laminated.

### Current Collector Terminal

The current collector terminal 15 may be electrically connected to the current collector foil 14. The material of the current collector terminal 15 is not particularly limited as long as it is a material having a current collector function, and can be, for example, the same metal material as that of the positive electrode current collector and the negative electrode current collector.

A method of bonding the current collector terminal and the current collector foil is not particularly limited, but an example of a method of bonding by ultrasonic waves is exemplified.

A method of welding the laminate film to the current collector terminal is not particularly limited, but a method of heat welding is exemplified.

The battery of the present disclosure may be a liquid-based battery or a solid-state battery. In the context of the present disclosure, a “solid battery” means a battery using at least a solid electrolyte as an electrolyte, and therefore a solid battery may use a combination of a solid electrolyte and a liquid electrolyte as an electrolyte. The solid-state battery of the present disclosure may be an all-solid-state battery, that is, a battery using only a solid electrolyte as an electrolyte.

The battery of the present disclosure may be a lithium-ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving of hybrid electric vehicle (HEV), plug-in hybrid electric vehicle (PHEV), or battery electric vehicle (BEV). Also, the battery in the present disclosure may be used as a power source for mobile bodies other than vehicles (for example, railroads, ships, and aircraft), and may be used as a power source for electric products such as an information processing device.

### Preparation of Electrode Laminate

### Example 1

A fixing member having a thick film region and a thin film region at both end portions was disposed on a pair of opposing side face portions of the electrode laminate in the following manner. That is, when an ultraviolet curable resin (Aronix, Toagosei Co., Ltd.) is applied to a pair of opposing side face portions of the electrode laminate using a dispenser, the end portion discharge amount is adjusted. Thus, the ultraviolet curable resin was applied so as to reduce the thickness of the end portion including the terminal end in the side face portion of the electrode laminate and to increase the thickness of the other portions. Then, the applied resin was irradiated with ultraviolet rays to cure the resin, and a fixing member was arranged. The thickness of the terminal end of the thin film region of the fixing member was 0.4 mm, and the thickness of the thick film region of the fixing member was 1 mm. In addition, the length of the thin film regions was 5 mm.

### Comparative Example 1

A fixing member was arranged in the same manner as in Example 1 except that a solid member having no thin film region was arranged on the side face portion of the electrode laminate.

### Evaluation

When 10 electrode laminates of Example 1 and Comparative Example 1 were prepared, the defective product rate in which peeling of the fixing member occurred was evaluated.

### Results

In the electrode laminate of Example 1 in which the fixing member having the predetermined thick film region and the thin film region was disposed, the defective product rate was 0%. On the other hand, in the electrode laminate of Comparative Example 1 in which the fixing member having no thin film region was disposed, the defective product ratio was 40%.

What is claimed is:

1. An electrode laminate, provided with a fixing member that includes a curable resin and that is disposed on at least one side face portion, wherein
the fixing member includes a thin film region and a thick film region,
the thin film region is fashioned on at least one end portion including a terminal end of the fixing member, and
the thick film region is fashioned in a portion other than the thin film region.

2. The electrode laminate according to claim 1, wherein:
a thickness of the fixing member is thinnest at the terminal end; and
a thickness of the terminal end is no more than 50% of a thickness of the thick film region.

3. The electrode laminate according to claim 1, wherein a length of the thin film region is no less than 1 mm.

4. The electrode laminate according to claim 1, wherein a thickness of the thick film region is no less than 50 μm and no more than 5 mm.

5. A battery comprising:
the electrode laminate according to claim 1; and
a laminate film that seals the electrode laminate.
